(19) United States
(12) Patent Application Publication
(10) Pub. No.: US 2009/0190570 A1
(43) Pub. Date: Jul. 30, 2009

(54) Methods and Device for Transmitting Data from a First Communication Device to a Second Communication Device

(75) Inventors: Ashok Kumar Marath, Singapore (SG); Ying Chang Liang, Singapore (SG); Anh Tuan Hoang, Singapore (SG); Yonghong Zeng, Singapore (SG); Wing Seng Leon, Singapore (SG)

Correspondence Address: CHOATE, HALL & STEWART LLP, TWO INTERNATIONAL PLACE, BOSTON, MA, 02110, US

(73) Assignee: AGENCY FOR SCIENCE, TECHNOLOGY AND RESEARCH, Centros (SG)

(21) Appl. No.: 12/092,965

(22) PCT Filed: Nov. 6, 2006
(86) PCT No.: PCT/SG06/00335

§ 371 Date: Nov. 21, 2008

Related U.S. Application Data
(60) Provisional application No. 60/734,114, filed on Nov. 7, 2005.
(60) Provisional application No. 60/734,080, filed on Nov. 7, 2005.
(60) Provisional application No. 60/796,355, filed on Apr. 28, 2006.

(51) Int. Cl. H04J 3/06; H04K 1/10

(52) U.S. Cl. 370/350; 375/260; 370/503; 370/280

(57) ABSTRACT

A method of transmitting data from a first communication device to a second communication device is provided. The method comprises transmitting at least one first data portion, transmitting a second data portion synchronized with the transmission of a corresponding data portion of a third communication device to the second communication device, and the transmission of the at least one first data portion being arranged such that it is received by the second communication device before the data portion of the third communication device corresponding to the second data portion.

The present application claims the benefit of U.S. provisional applications 60/734,114 (filed on 7 Nov., 2005), 60/734,080 (filed on 7 Nov., 2005) and 60/796,355 (filed on 28 Apr. 2006), the entire contents of which are incorporated herein by reference for all purposes.

The present invention refers to methods of transmitting data from a first communication device to a second communication device, as well as to the respective device.

Time division has been long used in communication technology. In many applications, time division is used to enable bidirectional communication on a single communication resource. This manner of using time division is known as time division duplex (TDD).

In typical TDD applications, time intervals are provided for downlink and uplink transmissions. In addition, a time gap is provided between downlink and uplink transmissions, as well as between uplink and downlink transmissions, to allow for the powering up or down of components when communication devices switch from a transmit mode to a receive mode, and vice versa. This time gap is usually small compared to the downlink and uplink time intervals.

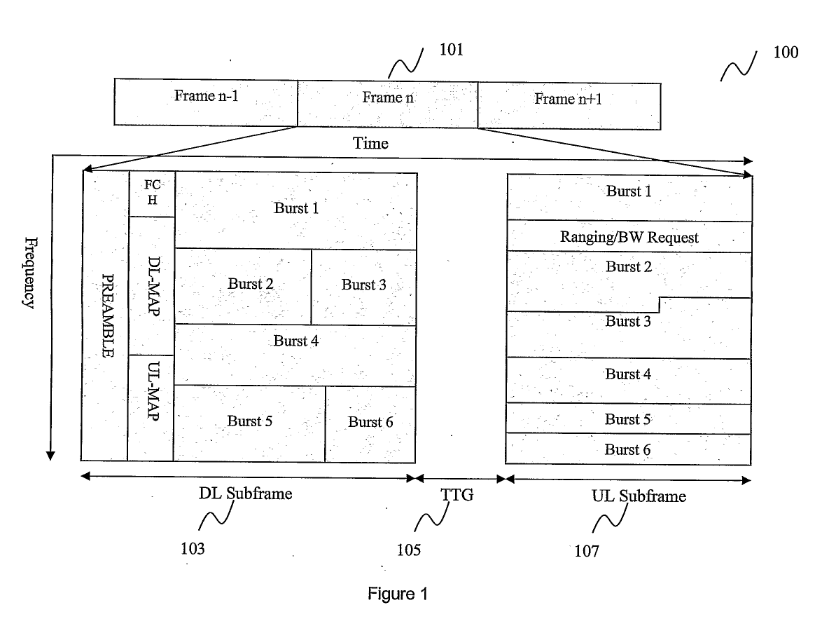

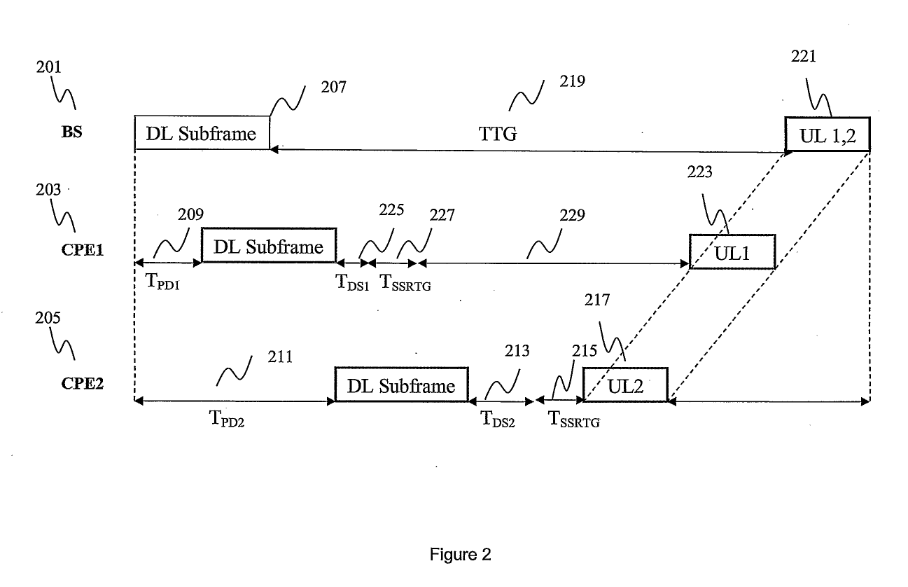

In some applications, the time gap may have additional uses. For example, in the proposed IEEE 802.22 wireless regional area network (WRAN) [1], the time gap between the uplink transmission and the downlink transmission may be used for sensing, or determining whether certain frequency ranges are being used or available for use. An illustration of the time gap mentioned in relation to the transmission frame structure is shown in FIG. 1. Another illustration of the time gap mentioned in relation to the downlink and uplink transmission process is shown in FIG. 2. Both these illustrations will be described in more detail subsequently.

A novel use of the time gap is introduced and described by the methods and device, as defined in the respective independent claims of the present application.

In a first aspect of the invention, a method of transmitting data from a first communication device to a second communication device is provided, comprising transmitting at least one first data portion, transmitting a second data portion synchronized with the transmission of a corresponding data portion of a third communication device to the second communication device, and the transmission of the at least one first data portion being arranged such that it is received by the second communication device before the data portion of the third communication device corresponding to the second data portion.

Embodiments of the invention emerge from the dependent claims.

Illustratively, when a first communication device is sufficiently near to a second communication device, as compared to a third communication device, it may be arranged for the first communication device to begin its transmission to the second communication device, earlier than scheduled without interfering with the transmission from the third communication device to the second communication device. In this illustration, the first communication device may be considered as “near” to the second communication device, while the third communication device may be considered as “far” to the second communication device.

The method described above has the following advantage, that it enables the otherwise unused free time to be used for data transmission, for example, which will increase the overall system data transmission throughput. In addition, if the unused free time is used for other functions, for example transmitting a pilot sequence, this may enable the system to have a better channel estimation, and thus a better system performance.

In one embodiment, the communication device may be, but is not limited to, a wireline communication device, a powerline communication device, a radio communication device, a terminal communication device or a Consumer Premise Equipment device. A radio communication device, for example, may be, but is not limited to, a mobile radio communication device, a satellite radio communication device, or a mobile radio base station.

While TDD is typically used in wireless communications, TDD may also be used in non-wireless communications. Accordingly, in this embodiment, the communication device may also be a wireline communication device or a powerline communication device.

The at least one first data portion may be sent during the time gap between the downlink transmission time interval and the uplink transmission time interval.

In one embodiment, the second data portion may be synchronized with the start of the uplink transmission time interval.

In order to prevent any collision of between the first data portion and the second data portion, it is necessary to arrange the transmissions such that the first data portion is completely received at the second communication device before the second data portion arrives. In addition, it is also possible that there may be a time gap between the end of the first data portion and the start of the second data portion at the second communication device.

In addition, if the first communication device is very near to the second communication device, it may be possible to transmit one or more first data portions. As the transmission propagation delay is very small due to the very near geographical distance between the first and second communication devices, therefore there is more time available to carry out transmissions. Accordingly, one or more first data portions may be transmitted.

However, if the geographical distance between the first and second communication devices is bigger, it may be possible to transmit only one first data portion. And, if the geographical distance between the first and second communication devices is very big, it may not be possible to transmit the first data portion at all. Accordingly, in one embodiment, the transmission of the at least one first data portion is dependent on the geographical distance between the first communication device and the second communication device.

Typically, it is possible to transmit only one first data portion, for example, if the geographical distance between the first communication device and the second communication device is within a predetermined range of geographical distances. Likewise, the first data portion may not be transmitted at all, for example if the geographical distance between the first and second communication devices is beyond a predetermined geographical distance. Accordingly, in one embodiment, a plurality of distance classes is used representing different geographical distances between the first communication device and the second communication device.

In one embodiment, the transmission of the at least one first data portion is provided at least partially in a time interval being arranged before an uplink time frame.

In one embodiment, timing information from the second communication device is received and at least one of the first portion and the second data portion are transmitted dependent on the received timing information. In another embodiment, the timing information is represented by a distance classification information representing the distance between the first communication device and the second communication device.

In one embodiment, a channel estimation is carried out.

In one embodiment, a number of allowed pre-symbols are determined that may be transmitted before the second data portion, and at least one pre-symbol is transmitted during or after the first data portion, and before the second data portion dependent on the determined number of allowed pre-symbols.

In one embodiment, the second data portion may be delayed in order to increase the size of the first data portion.

In one embodiment, a multiple access transmission technology is used. For example, the multiple access transmission technology is selected from a group of multiple access transmission technologies consisting of time division multiple access, frequency division multiple access, code division multiple access, and orthogonal frequency division multiple access.

In one embodiment, an orthogonal frequency division multiple access transmission technology is used and the length of a cyclic prefix or the length of an orthogonal frequency division multiple access symbol is adapted.

In particular, the cyclic prefix and symbol length used during the first data portion may be different from those used in the second data portion. The length of cyclic prefix and the length of an orthogonal frequency division multiple access symbol that may be used during the first data portion are dependent on the geographical distance between the first communication device and the second communication device. The length of cyclic prefix and the length of an orthogonal frequency division multiple access symbol that may be used during the second data portion are dependent on the geographical distance between the third communication device and the second communication device.

In one embodiment, the transmission is carried out in accordance with a data transmission frame structure, the data transmission frame structure comprising a first data transmission subframe including a downlink transmission subframe, a second data transmission subframe including an uplink transmission subframe, and a quiet transmission subframe representing a quiet time period, wherein the quiet transmission subframe is arranged between the first data transmission subframe and the second data transmission subframe.

As used herein, the term frame structure refers to the form which defines how a time interval is partitioned into a number of sub-intervals. In this context, a time interval of a predefined period is typically called a frame, and a sub-interval resulting from a predefined partitioning process is typically called a subframe. In this conjunction, an aggregate of a number of adjacent frames is typically called a superframe, or a frame group.

Typically, frames and sub-frames are used for data transmission. However, it is possible for a frame structure to have a number of frames and/or subframes assigned for non-data transmission functions, such as control functions. In this embodiment, a subframe is assigned for sensing.

Subframes may have the same or a different length (in terms of time). It is possible that subframes which are assigned for the same function may have the same length. For example, all downlink data transmission subframes may have the same length.

However, as explained before, subframes may have different lengths. For example, a subframe assigned for sensing and a downlink data transmission subframe may have different lengths. In another example, an uplink data transmission subframe and a downlink data transmission subframe may also have different lengths.

Likewise, frames may have the same or a different length.

As used herein, the term sensing refers to determining the available frequency ranges within a plurality of frequency ranges. In this regard, the term sensing sub-frame refers to a quiet period of a predefined length. For example, the sensing subframe may be, but is not limited to, the Transmit-Receive Transition Gap (TTG) in the system of [1]. Accordingly, in one embodiment, the method provided further comprises determining available frequency ranges during a time period being represented by the quiet transmission subframe.

In addition, as used herein, downlink transmission refers to a transmission in the direction from the second communication device to the first communication device. In contrast to downlink transmission, uplink transmission refers to a transmission in the direction from the first communication device to the second communication device.

In one embodiment, a further downlink transmission time interval is provided after the determination of the available frequency ranges.

In one embodiment, a plurality of further downlink transmission time intervals is provided after the determination of the available frequency ranges.

In one embodiment, a plurality of further uplink transmission time intervals is provided after the determination of the available frequency ranges.

In one embodiment, a predetermined time period is waited after the downlink transmission time interval, and available frequency ranges within a plurality of frequency ranges are determined after expiration of the predetermined time period. In another embodiment, the predetermined time period is dimensioned such that the downlink transmission signals have been completely transmitted via the frequency ranges.

In one embodiment, the method is carried out within at least one data transmission frame structure, wherein the data transmission frame structure comprises a downlink subframe provided for the downlink transmission time interval, a sensing subframe provided for the determining of the available frequency, and an uplink subframe provided for the uplink transmission time interval, wherein the sensing subframe being arranged between the downlink subframe and the uplink subframe.

In one embodiment, the method is carried out within at least one data transmission frame structure, wherein the data transmission frame structure comprises a frame group comprising a header portion and a plurality of frames, wherein the header portion comprises a downlink subportion for the downlink transmission time interval, and a sensing subportion provided for the determining of the available frequency.

In one embodiment, available frequency ranges are determined within a plurality of frequency ranges, the available frequency ranges are combined to at least one combined logical frequency range, and the at least one combined logical frequency range is allocated to the first communication device.

In one embodiment, a plurality of frequency ranges are scanned, and it is determined, whether a signal transmission in a respective frequency range is below a predetermined threshold. In the case where the signal transmission in the respective frequency range is below the predetermined threshold, the frequency range is classified as available frequency range. In the case where the signal transmission in the respective frequency range is not below the predetermined threshold, the frequency range is skipped or the frequency range is classified as being non-available.

In one embodiment, control information from the second communication device is received by the first communication device. In another embodiment, the control information from the second communication device received by the first communication device may be information on whether transmission of first data portion is allowed, information on the start of the transmission of first data portion, information on when transmission of first data portion is allowed, the duration of the transmission of first data portion when the transmission of first data portion is allowed or information on whether a pre-symbol is transmitted.

In one embodiment, the data transmission parameters for the first data portion may be different from the data transmission parameters for the second data portion. The data transmission parameters, for example, may be, but are not limited to, signal modulation parameters, such as method of data modulation, and coding parameters, such method of encoding and encoding rate. The method of data modulation, for example, may be but are not limited to, binary phase shift keying (BPSK), quadrature phase shift keying (QPSK) and quadrature amplitude modulation (QAM). The method of encoding, for example, may be but is not limited to, convolutional code, turbo code, block code and turbo product code (TPC).

In a second aspect of the invention, a method of transmitting data from a first communication device to a second communication device is provided, comprising transmitting at least one first data portion, transmitting a second data portion synchronized with the transmission of a corresponding data portion of a third communication device to the second communication device, and the transmission of the at least one first data portion being arranged dependent on the geographical distance of the first communication device from the second communication device.

In a third aspect of the invention, a method of generating a data transmission frame structure for transmitting data from a first communication device to a second communication device is provided. The method comprises generating a first data transmission subframe including a downlink transmission subframe, generating a second data transmission subframe including an uplink transmission subframe, generating a quiet transmission subframe representing a quiet time period, wherein the quiet transmission subframe is arranged between the first data transmission subframe and the second data transmission subframe.

In a fourth aspect of the invention, a communication device transmitting to another communication device is provided, comprising a transmitter transmitting at least one first data portion and a second data portion synchronized with the transmission of a corresponding data portion of a third communication device to the other communication device, and the transmission of the at least one first data portion is arranged such that it is received by the second communication device before the data portion of the third communication device corresponding to the second data portion.

As defined earlier, the communication device may be, but is not limited to, a wireline communication device, a powerline communication device, a radio communication device, a terminal communication device or a Consumer Premise Equipment device. A radio communication device, for example, may be, but is not limited to, a mobile radio communication device, a satellite radio communication device, or a mobile radio base station.

The embodiments which are described in the context of the methods of method of transmitting data from a first communication device to a second communication device provided, are analogously valid for the device.

FIG. 1 shows a frame structure of a time division duplexing (TDD) system.

FIG. 2 shows an illustration of the transmission process of a TDD system.

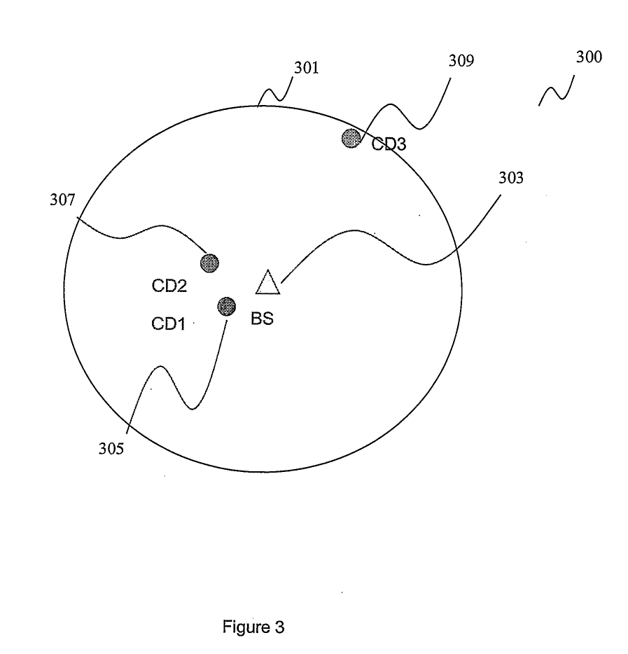

FIG. 3 shows a communication system according to an embodiment of the invention.

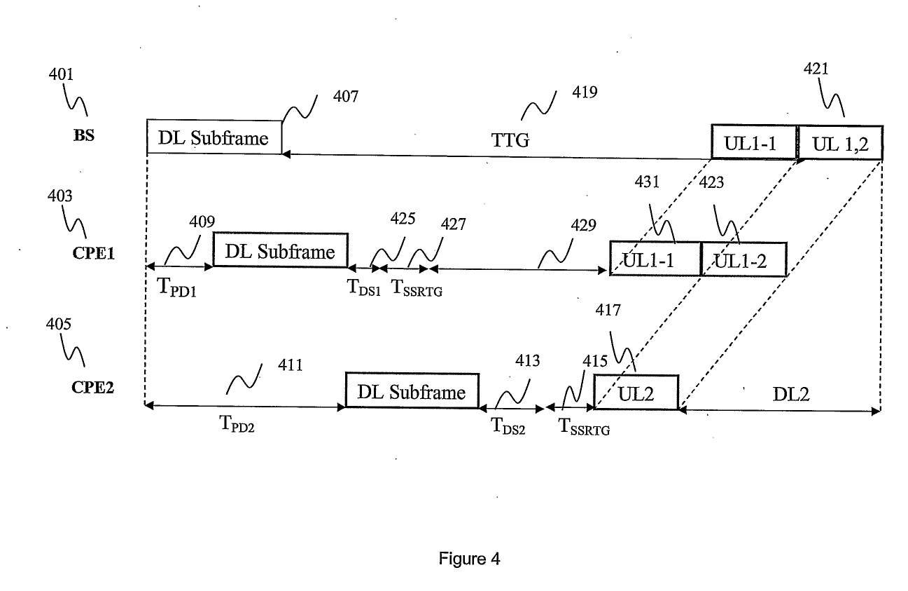

FIG. 4 shows an illustration of the transmission process of a TDD system according to an embodiment of the invention.

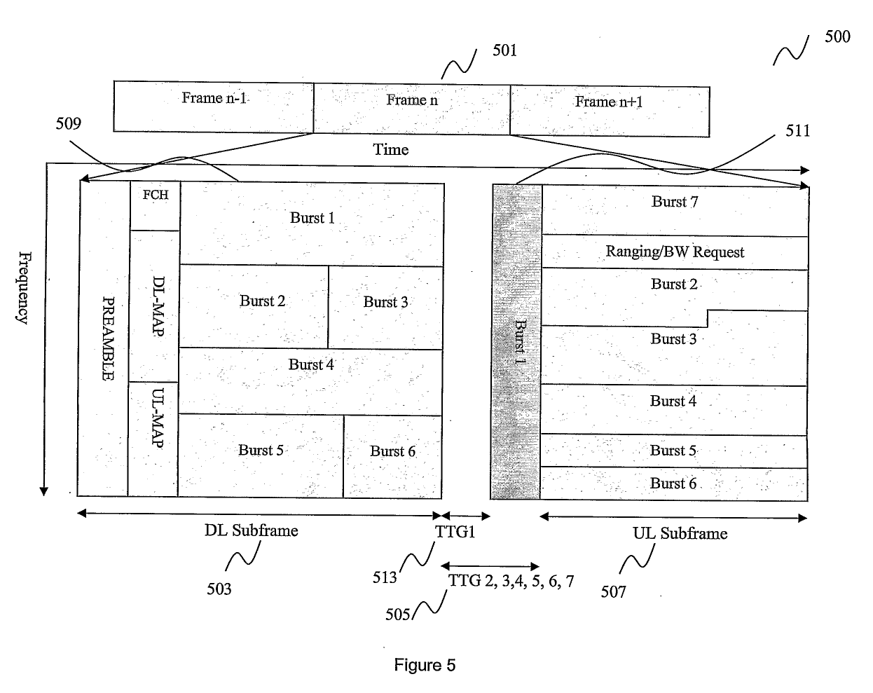

FIG. 5 shows a frame structure of a TDD system according to an embodiment of the invention.

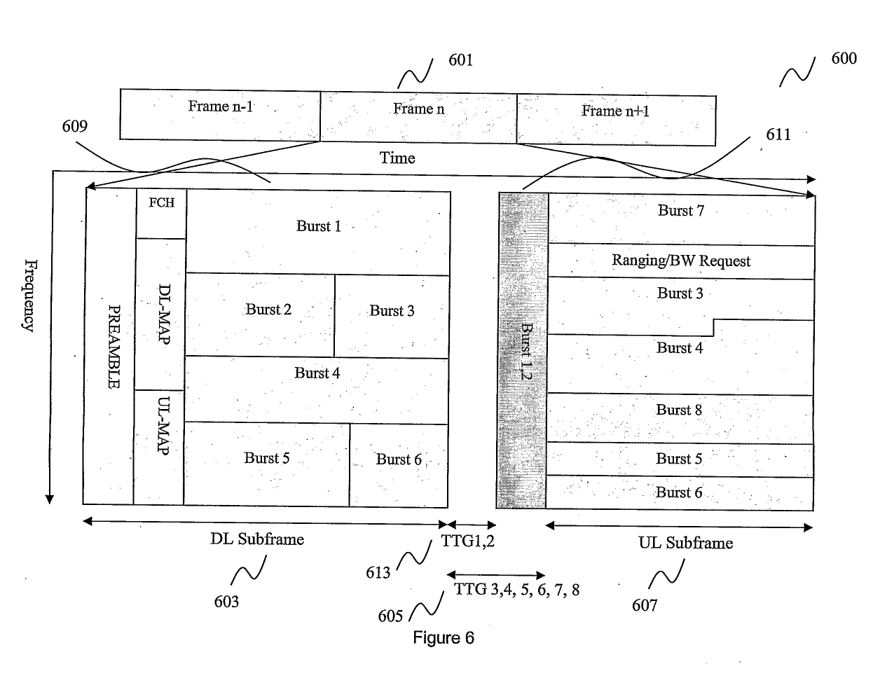

FIG. 6 shows another frame structure of a TDD system according to an embodiment of the invention.

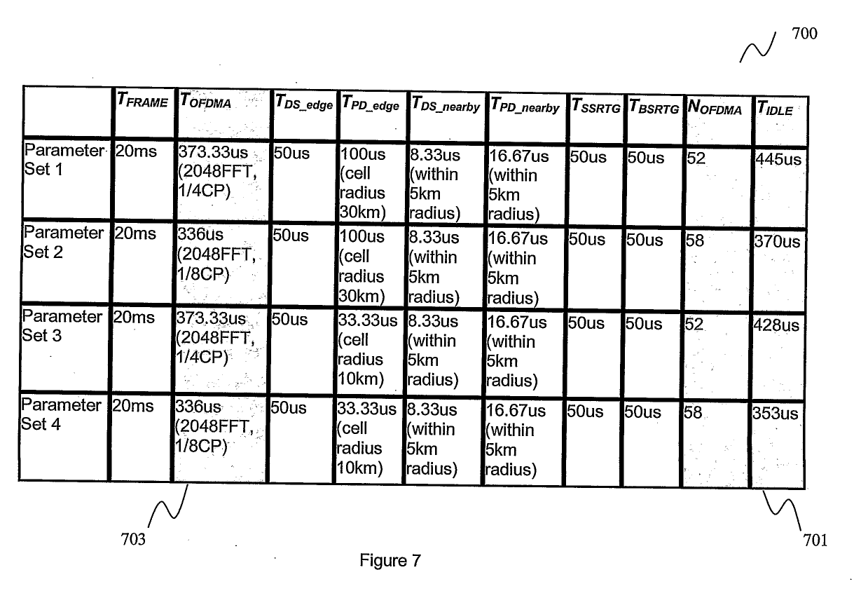

FIG. 7 shows a table of parameters used in the transmission process of a TDD system according to an embodiment of the invention.

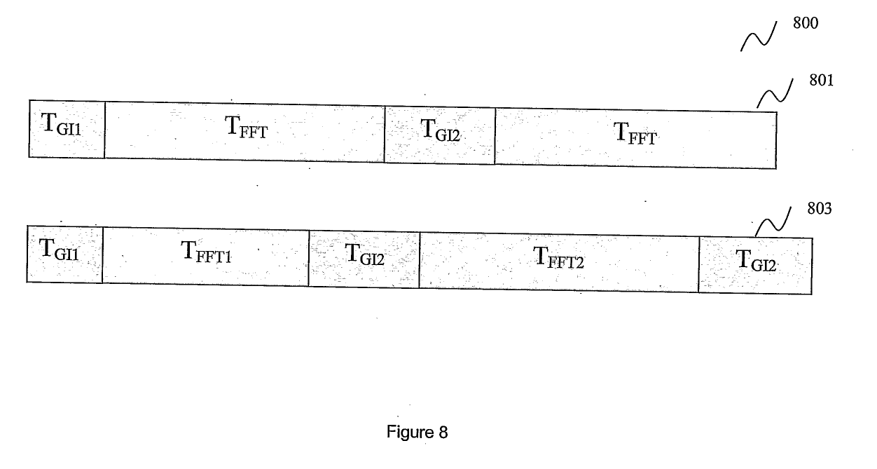

FIG. 8 shows an illustration of the changes in the frame structure in a TDD system according to an embodiment of the invention.

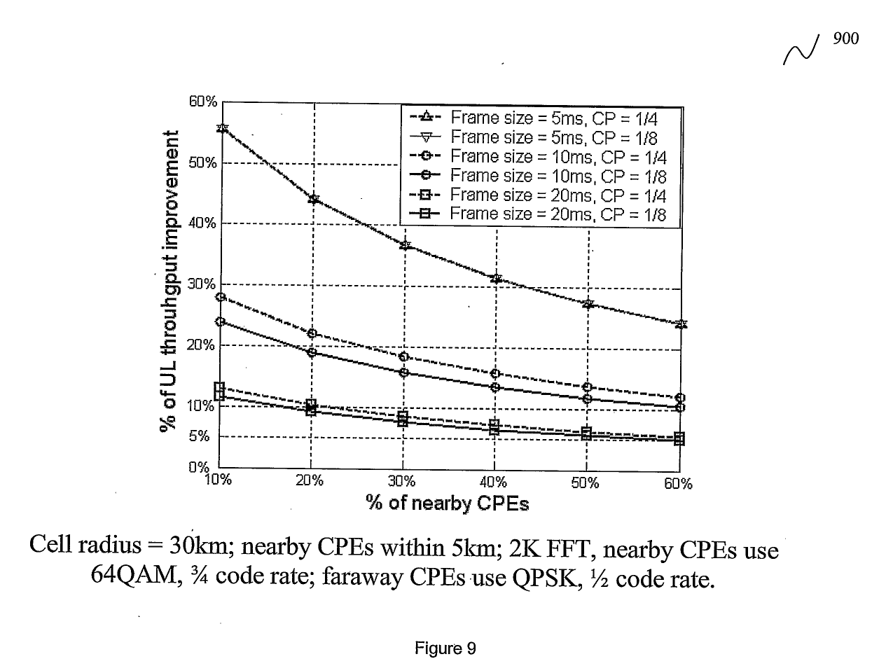

FIG. 9 shows the performance results of a TDD system according to an embodiment of the invention.

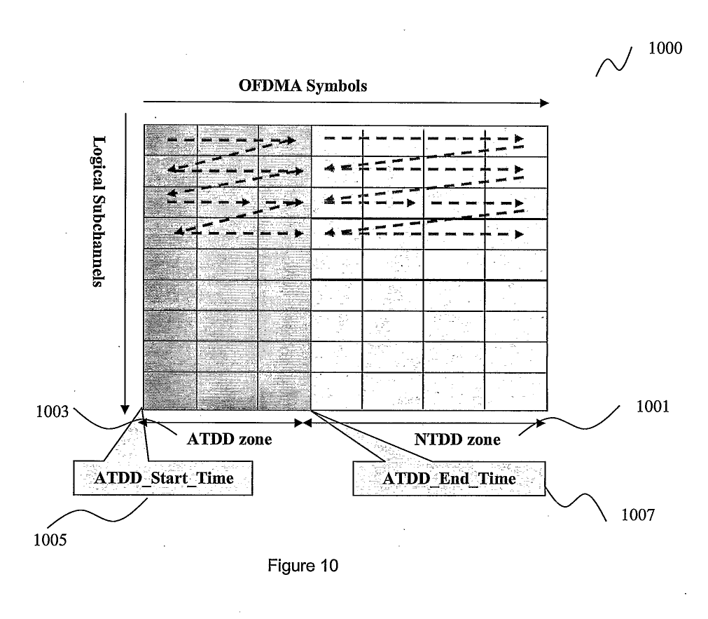

FIG. 10 shows another illustration of the transmission process of a TDD system according to an embodiment of the invention.

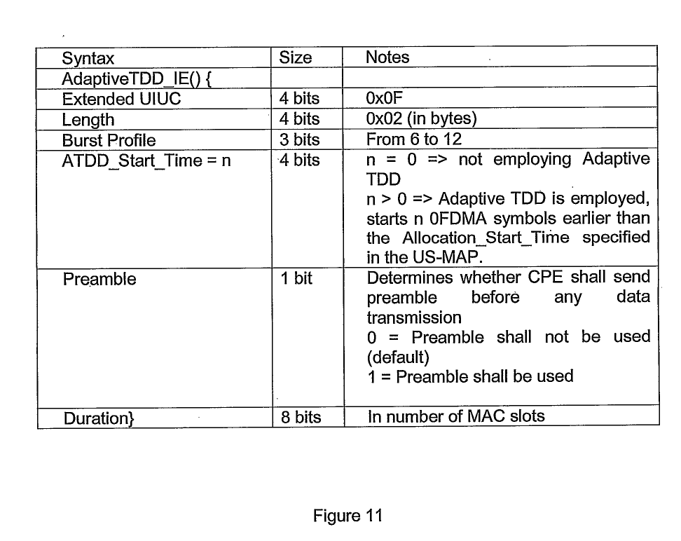

FIG. 11 shows an example of the Information Element (IE) of a communication message according to an embodiment of the invention.

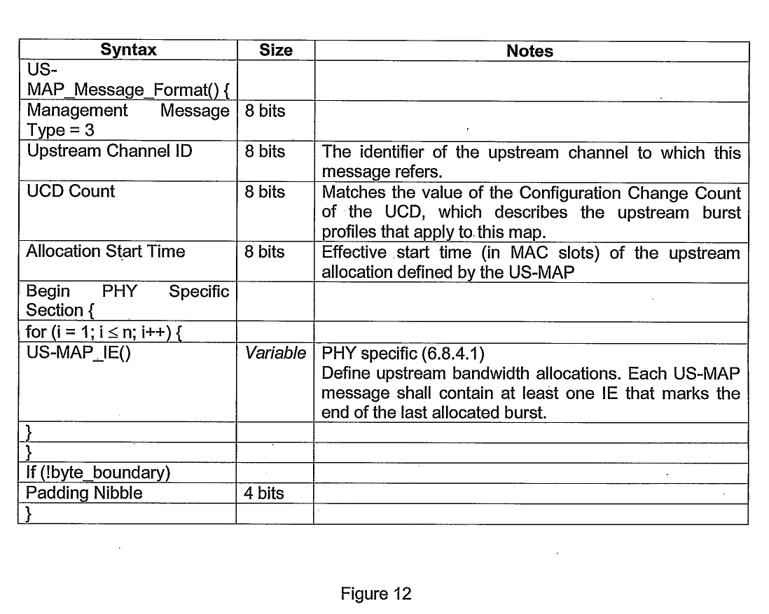

FIG. 12 shows an example of a communication message according to an embodiment of the invention.

FIG. 1 shows a frame structure 100 of an example TDD system.

As shown in FIG. 1, a frame 101 comprises a downlink (DL) subframe 103, a TTG 105 and an uplink (UL) subframe 107. Frame 101 illustrates the main components of a TDD system, the downlink transmission, the time gap between a downlink transmission and an uplink transmission respectively. The frame structure 100 is used in the proposed IEEE 802.22 wireless regional area network (WRAN) [1], and also in IEEE 802.16.d and IEEE 802.16.e standards.

However, there is also a corresponding time gap between an uplink transmission and a downlink transmission which is not shown in FIG. 1. For the proposed IEEE 802.22 WRAN, this time gap is called the Receive-Transmit Transition Gap (RTG).

FIG. 2 shows an illustration of the transmission process of an example TDD system.

In this illustration, using the proposed IEEE 802.22 WRAN as an example, the cell in the WRAN network consists of a base station (BS) 201 and 2 customer premises equipments (CPE), the first customer premises equipment (CPE1) 203 and the second customer premises equipment (CPE2) 205. The first customer premises equipment (CPE1) 203 is geographically nearer to the base station (BS) 201 than the second customer premises equipment (CPE2) 205.

When a transmission during the downlink subframe 207 is made from the base station 201, it takes some time before reaching the first customer premises equipment (CPE1) 203. This time is typically called a propagation delay. As the first customer premises equipment (CPE1) 203 is nearer to the base station 201 compared to the second customer premises equipment (CPE2) 205, the propagation delay to the first customer premises equipment (CPE1) 203, T_{PD1} 209, is smaller compared to the propagation delay to the second customer premises equipment (CPE2) 205, T_{PD2} 211.

When the transmission during the downlink subframe 207 finally arrives at the second customer premises equipment (CPE2) 205, the second customer premises equipment (CPE2) 205 waits for a short period T_{DS2} 213 to ensure that the reception of the transmission during the downlink subframe 207 is completed, before switching from the receive mode to the transmit mode. The time required to complete this switching process is denoted as T_{SSRTG} 215. The transmission during the uplink subframe for the second customer premises equipment (CPE2), denoted by UL2 217, is then made to the base station BS 201. The transmission during the uplink subframe for the second customer premises equipment UL2 217 finally reaches the base station BS 201 after a period denoted by TTG 219 from the transmission of downlink subframe 207, where TTG is the Transmit-Receive Time Gap.

The base station BS 201 receives the uplink transmissions UL1,2 221, where the uplink transmissions UL1,2 221 consists of the uplink transmission UL1 223 and the uplink transmission UL2 217. Both the uplink transmissions UL1 223 and UL2 217 are synchronized as they arrive at the BS 201 at the same time, but the uplink transmission UL1 223 is transmitted on a different frequency channel compared to the uplink transmission UL2 217.

In this regard, it can be seen at the first customer premises equipment (CPE1) 203 that after considering a corresponding waiting time T_{DS2} 225 and a corresponding switching time T_{SSRTG} 227, there is a considerable amount of ‘free’ time 229 before the uplink transmission UL1 223 is transmitted. It can also be seen that this ‘free’ time 229 is larger when the geographical distance between the first customer premises equipment (CPE1) 203 and the base station BS 201 is nearer.

FIG. 3 shows a communication system 300 according to an embodiment of the invention.

The communication system 300 comprises a communication system cell 301, which comprises a base station (BS) 303, a first communication device (CD1) 305, a second first communication device (CD2) 307 and a third first communication device (CD3) 309.

The communication system 300 may represent the proposed IEEE 802.22 wireless regional area network (WRAN) [1], which is an example of the other communication services operating based on the concept of opportunistic spectrum access. The proposed IEEE 802.22 WRAN operates in the very high frequency (VHF) and the ultra high frequency (UHF) frequency band (between 47 MHz and 910 MHz), which have already been allocated for the use of TV broadcast and Part 74 wireless microphone devices.

In order to avoid causing interference to TV broadcasts and to Part 74 devices, WRAN devices, such as base stations (BS) and customer premise equipment (CPE), must be able to carry out a reliable detection of the incumbent communication services, while determining the availability of the frequency ranges in which they are operating.

In this regard, the communication devices (CD1 305, CD2 307 and CD3 309) may be consumer premises equipment (CPE).

FIG. 4 shows an illustration of the transmission process of a TDD system according to an embodiment of the invention.

Similar to FIG. 2, in this illustration, using the proposed IEEE 802.22 WRAN as an example, the cell in the WRAN network consists of a base station (BS) 401 and 2 customer premises equipments (CPE), the first customer premises equipment (CPE1) 403 and the second customer premises equipment (CPE2) 405. The first customer premises equipment (CPE1) 403 is geographically nearer to the base station (BS) 401 than the second customer premises equipment (CPE2) 405. As a further illustration using FIG. 3, the first customer premises equipment (CPE1) 403 may be the first communication device CD1 305 or the second communication device CD2 307, while the second customer premises equipment (CPE2) 405 may be the third communication device CD3 309.

When a transmission during the downlink subframe 407 is made from the base station 401, it takes some time before reaching the first customer premises equipment (CPE1) 403, due to the propagation delay. As the first customer premises equipment (CPE1) 403 is nearer to the base station 401 compared to the second customer premises equipment (CPE2) 405, the propagation delay to the first customer premises equipment (CPE1) 403, T_{PD1} 409, is smaller compared to the propagation delay to the second customer premises equipment (CPE2) 405, T_{PD2} 411.

When the transmission during the downlink subframe 407 finally arrives at the second customer premises equipment (CPE2) 405, the second customer premises equipment (CPE2) 405 waits for a short period T_{DS2} 413 to ensure that the reception of the transmission during the downlink subframe 407 is completed, before switching from the receive mode to the transmit mode. The time required to complete this switching process is denoted as T_{SSRTG} 415. The transmission during the uplink subframe for the second customer premises equipment (CPE2), denoted by UL2 417, is then made to the base station BS 401. The transmission during the uplink subframe for the second customer premises equipment UL2 417 finally reaches the base station BS 401 after a period denoted by TTG 419 from the transmission of downlink subframe 407, where TTG is the Transmit-Receive Time Gap.

Unlike FIG. 2, in this case, since there is significant amount of “free” time between receiving the downlink transmission and starting the uplink transmission (which comprises the sum of the time intervals denoted by 429 and 431), the first customer premises equipment (CPE1) 403 begins its uplink transmission early. It can be seen that this “free” time will be larger when the geographical distance between the first customer premises equipment (CPE1) 403 and the base station BS 401 is nearer.

With the early transmission, the first customer premises equipment (CPE1) 403 transmits the first portion of its uplink transmission denoted as UL1-1 431 earlier. Accordingly, the second portion of its uplink transmission is denoted as UL1-2 423.

The base station BS 401 receives the uplink transmission UL1-1 431 first, and then followed by the uplink transmissions UL1,2 421, where the uplink transmissions UL1,2 421 comprises the uplink transmission UL1-2 423 and the uplink transmission UL2 417. Similar to FIG. 2, both the uplink transmissions UL1-2 423 and UL2 417 are synchronized as they arrive at the BS 401 at the same time, but the uplink transmission UL1-2 423 is transmitted on a different frequency channel compared to the uplink transmission UL2 417.

In order for the first customer premises equipment (CPE1) 403 to begin its uplink transmission earlier, there are several requirements which are met in this embodiment. Firstly, it is required that the base station BS 401 knows about the earlier transmission of the first customer premises equipment (CPE1) 403. Otherwise, the base station BS 401 may not be ready to receive this early transmission. Therefore, control information is exchanged before the early transmission is carried.

Secondly, the second portion of its uplink transmission UL1-2 423 is synchronized such that the start of a normal transmission (for example, the uplink transmission UL2 417), and the start of the second portion of its uplink transmission UL1-2 423, arrive at the base station BS 401 at approximately the same time. This requirement is needed in order to preserve the existing frame boundaries.

Thirdly, the early transmission is carried out by the first customer premises equipment (CPE1) 403 only if the first customer premises equipment (CPE1) 403 is sufficiently near to the base station BS 401. In this regard, when the first customer premises equipment (CPE1) 403 is very near to the base station BS 401, it is possible that the first customer premises equipment (CPE1) 403 may transmit more than one first portion of the uplink transmission, if it is a system requirement that the first portion of the uplink transmission to be of a predetermined size. On the other hand, if it is not a system requirement that the first portion of the uplink transmission to be of a predetermined size, then the first customer premises equipment (CPE1) 403 may transmit a larger first portion of the uplink transmission when the first customer premises equipment (CPE1) 403 is very near to the base station BS 401.

For example, in the proposed IEEE 802.22 WRAN [1], which uses orthogonal frequency division multiple access (OFDMA) as the multiple access technology, it is a system requirement that the first portion of the uplink transmission to be multiples of an OFDMA symbol. Therefore, in this case, it is possible for the first customer premises equipment (CPE1) 403 to transmit more than one first portion of the uplink transmission, where the size of the first portion of the uplink transmission is fixed as one OFDMA symbol.

In contrast to early uplink transmission, it is also possible to implement a ‘late’ uplink transmission scheme. The time obtained from a ‘late’ uplink transmission may be used to transmit, for example, control information, or pilots to improve channel estimation.

A late uplink transmission may also be used to increase the size of the first data portion. For example, using the illustration in FIG. 4, a late uplink transmission may be imposed on CPE2 (405) in order to increase the size of the early uplink transmission portion of CPE1 (403).

FIG. 5 shows a frame structure 500 of a TDD system according to an embodiment of the invention.

Similar to FIG. 1, in this illustration, a frame 501 comprises a downlink (DL) subframe 503, a Transmit-Receive Transition Gap (TTG) 505 (denoted by TTG2,3,4,5,6,7), and an uplink (UL) subframe 507. Frame 501 illustrates the main components of a TDD system, the downlink transmission, the time gap between a downlink transmission and an uplink transmission respectively.

However, there is also a corresponding time gap between an uplink transmission and a downlink transmission which is not shown in FIG. 5. For the proposed IEEE 802.22 WRAN, this time gap is called the Receive-Transmit Transition Gap (RTG).

In this embodiment, the frame structure 500 is for the proposed IEEE 802.22 WRAN cell with a base station BS and 7 consumer premises equipment CPEs. For example, Burst 1 in the downlink subframe 509 and Burst 1 in the uplink subframe 511 are transmissions related to the first customer premises equipment (CPE1), where Burst 1 in the uplink subframe 511 is an early uplink transmission. Accordingly, the Transmit-Receive Transition Gap TTG for the first customer premises equipment (CPE1) TTG1 513 is shorter for the Transmit-Receive Transition Gap TTG used for the other customer premises equipment CPEs TTG2,3,4,5,6,7 505.

FIG. 6 shows another frame structure 600 of a TDD system according to an embodiment of the invention.

In this illustration, the items labeled 600-613 corresponds to the items labeled 500-513 respectively in FIG. 5. However, in this embodiment, the early uplink transmission is shared by Burst 1,2 611, i.e., the combination of the uplink transmission of the first customer premises equipment (CPE1) and the uplink transmission of the second customer premises equipment (CPE2). In this case, for example, the uplink transmission of the first customer premises equipment (CPE1) may use certain frequency channels and the uplink transmission of the second customer premises equipment (CPE2) may use other frequency channels not being used by the first customer premises equipment (CPE1). Accordingly, TTG4,5,6,7 405 is the Transmit-Receive Transition Gap TTG used for the customer premises equipment CPEs 4, 5, 6 and 7, and TTG1,2 is the Transmit-Receive Transition gap TTG used for the customer premises equipment CPEs 1 and 2.

FIG. 7 shows a table of parameters 700 used in the transmission process of a TDD system according to an embodiment of the invention. These parameters are obtained for several variations of the proposed IEEE 802.22 WRAN, which uses OFDMA. It can be seen that the idle time T_{IDLE} 701 is always greater than the OFDMA symbol time T_{OFDMA} 703 for all parameter sets. This means that for the proposed IEEE 802.22 WRAN, it is always possible to allow early uplink transmission even with cells at its maximum size of 33 km radius. For illustration purposes, the idle time T_{IDLE} 701 may be represented by item 229 in FIG. 2.

FIG. 8 shows an illustration of the changes in the frame structure in a TDD system according to an embodiment of the invention. In the case of the proposed IEEE 802.22 WRAN, it is further possible to increase the amount of idle time for near customer premises equipment CPEs for use in transmission, by reducing the length of the cyclic prefix (CP) and the Fast Fourier Transform (FFT) size. This is because nearby customer premises equipment CPEs experience a shorter delay spread, and hence, do not need long cyclic prefixes CPs. The diagram 801 shows the normal case, while the diagram 803 shows the case where the length of the cyclic prefix (CP) and the Fast Fourier Transform (FFT) size have been reduced.

FIG. 9 shows the performance results 900 of a TDD system according to an embodiment of the invention.

Using the proposed IEEE 802.22 WRAN in this illustration, a customer premises equipment CPE is defined as a near device if it is located within a geographically distance of 5 km from the BS. In this case, a near customer premises equipment CPE is also allowed to use a higher data transmission rate with 64-QAM modulation in conjunction with a rate % coding rate, since nearer customer premises equipment CPEs typically have a higher signal-to-noise ratio (SNR).

From the performance results graph 800 obtained from simulations, it can be seen that it is possible to obtain a nearly 55% improvement in UL throughput for the case of 10% of all customer premises equipment CPEs being near customer premises equipment CPEs, with a frame size of 5 ms and the use of ¼ CP. In addition, performance improvement is observed in all other cases as well. These results indicates that performance improvements may be expected when the methods and device provided by this invention is implemented on an actual system.

FIG. 10 shows another illustration of the transmission process of a TDD system according to an embodiment of the invention.

In this illustration, the normal uplink transmission time interval is denoted by normal Time Division Duplex (NTDD zone) 1001 and the early uplink transmission time interval is denoted by adaptive TDD (ATDD) zone 1003. Two parameters, ATDD_Start_Time 1005 and ATDD_End_Time 1007, denote the start and end times respectively of the early uplink transmission.

FIG. 11 shows an example of the Information Element (IE) of a communication message according to an embodiment of the invention.

The Information Element shown in FIG. 11, for example, may be used in a communication message to inform communication devices on when or how early uplink transmission will be carried out. For example, the ATDD_Start_Time parameter in the Information Entity shown in FIG. 11 is illustrated in FIG. 10.

FIG. 12 shows an example of a communication message according to an embodiment of the invention.

The communication message shown in FIG. 12 is an example of a communication message which may be used to inform communication devices on when or how early uplink transmission will be carried out. In addition, for example, the ATDD_End_Time parameter shown in FIG. 10 may be set using the Allocation Start Time parameter in FIG. 12.

In addition, for all communication systems employing TDD, there are already schemes, such initial ranging and periodic ranging, which may be used by the base station BS and the customer premises equipment CPEs to determine the propagation delay. The propagation delay related parameters may then be used to determine which customer premises equipment CPEs are near to the base station BS, which could be allowed to start early uplink transmission.

In this document, the following publication is cited:

[1] “A PHY/MAC Proposal for IEEE 802.22 WRAN System, Part 2: The Cognitive MAC”, by ETRI, FT, HuaWei, I2R, Motorola, NextWave, Philips, Runcom, Samsung, STM, Thomson, March 2006.

What is claimed is:

1. A method of transmitting data from a first communication device to a second communication device, comprising
transmitting at least one first data portion;
transmitting a second data portion synchronized with the transmission of a corresponding data portion of a third communication device to the second communication device; and
the transmission of the at least one first data portion being arranged such that it is received by the second communication device before the data portion of the third communication device corresponding to the second data portion.

2. The method of claim 1,
the transmission of the at least one first data portion being dependent on the geographical distance between the first communication device and the second communication device.

3. The method of claim 1,
using a plurality of distance classes representing different geographical distances between the first communication device and the second communication device.

4. The method of claim 1,
the transmission of the at least one first data portion being provided at least partially in a time interval being arranged before an uplink time interval.

5. The method of claim 1, further comprising
receiving timing information from the second communication device; and
transmitting at least one of the first and second data portions dependent on the received timing information.

6. The method of claim 5,
the timing information being represented by a distance classification information representing the distance between the first communication device and the second communication device.

7. The method of claim 1, further comprising
carrying out a channel estimation.

8. The method of claim 1, further comprising
determining a number of allowed pre-symbols that may be transmitted before the second data portion;
transmitting at least one pre-symbol during or after the first data portion, and before the second data portion dependent on the determined number of allowed pre-symbols.

9. The method of claim 1, further comprising
using a multiple access transmission technology.

10. The method of claim 9,
the multiple access transmission technology being selected from a group of multiple access transmission technologies consisting of:
time division multiple access,
frequency division multiple access,
code division multiple access,
orthogonal frequency division multiple access.

11. The method of claim 1,
using an orthogonal frequency division multiple access transmission technology; and
adapting the length of cyclic prefix and/or the length of an orthogonal frequency division multiple access symbol.

12. The method of claim 1,
the transmission being carried out in accordance with a data transmission frame structure, the data transmission frame structure comprising
a first data transmission subframe including a downlink transmission subframe;
a second data transmission subframe including an uplink transmission subframe;
a quiet transmission subframe representing a quiet time period, the quiet transmission subframe being arranged between the first data transmission subframe and the second data transmission subframe.

13. The method of claim 12, further comprising
determining available frequency ranges during a time period being represented by the quiet transmission subframe.

14. The method of claim 13, further comprising
providing a further downlink transmission time interval after the determination of the available frequency ranges.

15. The method of claim 13, further comprising
providing a plurality of further downlink transmission time intervals after the determination of the available frequency ranges.

16. The. method of claim 13, further comprising
providing a plurality of further uplink transmission time intervals after the determination of the available frequency ranges.

17. The method of claim 13, further comprising
waiting a predetermined time period after the downlink transmission time interval;
determining available frequency ranges within a plurality of frequency ranges after expiration of the predetermined time period.

18. The method of claim 17,
the predetermined time period being dimensioned such that the downlink transmission signals have been completely transmitted via the frequency ranges.

19. The method of claim 1,
the method being carried out within at least one data transmission frame structure, wherein the data transmission frame structure comprises
a downlink subframe provided for the downlink transmission time interval;
a sensing subframe provided for the determining of the available frequency; and
an uplink subframe provided for the uplink transmission time interval;
the sensing subframe being arranged between the downlink subframe and the uplink subframe.

20. The method of claim 1,
the method being carried out within at least one data transmission frame structure, wherein the data transmission frame structure comprises a frame group comprising a header portion and a plurality of frames
the header portion comprising a downlink subportion for the downlink transmission time interval; and
a sensing subportion provided for the determining of the available frequency.

21. The method of claim 1, further comprising
determining available frequency ranges within a plurality of frequency ranges;
combining the available frequency ranges to at least one combined logical frequency range; and
allocating the at least one combined logical frequency range to the first communication device.

22. The method of claim 1, further comprising
scanning a plurality of frequency ranges
determining, whether a signal transmission in a respective frequency range is below a predetermined threshold,
in case the signal transmission in the respective frequency range is below the predetermined threshold, then classifying frequency range as available frequency range;
in case the signal transmission in the respective frequency range is not below the predetermined threshold, then skipping frequency range or classifying frequency range as being non-available.

23. A method of transmitting data from a first communication device to a second communication device, comprising
transmitting at least one first data portion;
transmitting a second data portion synchronized with the transmission of a corresponding data portion of a third communication device to the second communication device; and
the transmission of the at least one first data portion being arranged dependent on the geographical distance of the first communication device from the second communication device.

24. A method of generating a data transmission frame structure for transmitting data from a first communication device to a second communication device, the method comprising
generating a first data transmission subframe including a downlink transmission subframe;
generating a second data transmission subframe including an uplink transmission subframe;
generating a quiet transmission subframe representing a quiet time period, the quiet transmission subframe being arranged between the first data transmission subframe and the second data transmission subframe.

25. A communication device transmitting to another communication device, comprising
a transmitter transmitting at least one first data portion and a second data portion synchronized with the transmission of a corresponding data portion of a third communication device to the other communication device; and the transmission of the at least one first data portion being arranged such that it is received by the second communication device before the data portion of the third communication device corresponding to the second data portion.

26. The communication device of claim 25,
being a wireline communication device.

27. The communication device of claim 25,
being a powerline communication device.

28. The communication device of claim 25,
being a radio communication device.

29. The communication device of claim 28,
being a mobile radio communication device.

30. The communication device of claim 28,
being a satellite radio communication device.

31. The communication device of claim 28,
being a mobile radio base station.

32. The communication device of claim 25,
being a terminal communication device.

33. The communication device of claim 25,
being a Consumer Premise Equipment device.

34. The method of claim 1, further comprising
receiving control information from the second communication device by the first communication device.

35. The method of claim 34, wherein the control information comprises at least one of the following
whether transmission of first data portion is allowed;
the start of the transmission of first data portion;
when transmission of first data portion is allowed; and
the duration of the transmission of first data portion, when transmission of first data portion is allowed.

36. The method of claim 35, wherein the control information further comprises whether a pre-symbol is transmitted.

37. The method of claim 11, further comprising
determining the length of cyclic prefix and/or the length of an orthogonal frequency division multiple access symbol that may be used during the first data portion; and
determining the length cyclic prefix and/or the length of an orthogonal frequency division multiple access symbol that may be used during the second data portion.

38. The method of claim 11, wherein
the length of cyclic prefix and the length of an orthogonal frequency division multiple access symbol that may be used during the first data portion being dependent on the geographical distance between the first communication device and the second communication device; and
the length of cyclic prefix and the length of an orthogonal frequency division multiple access symbol that may be used during the second data portion being dependent on the geographical distance between the third communication device and the second communication device.

39. The method of claim 11, wherein the data transmission parameters for the first data portion being different from the data transmission parameters for the second data portion.
